(19) United States
(12) Patent Application Publication
(10) Pub. No.: US 2021/0185232 A1
(43) Pub. Date: Jun. 17, 2021

(54) APPARATUS OF SHAKING COMPENSATION AND METHOD OF SHAKING COMPENSATION

(71) Applicant: APOSTERA GMBH, Unterföhring (DE)

(72) Inventor: Viktor Yuriyovych SDOBNIKOV, Kyiv (UA)

(21) Appl. No.: 17/268,786

(22) PCT Filed: Dec. 28, 2019
(86) PCT No.: PCT/UA2019/000171

§ 371 Date: Feb. 16, 2021

(30) Foreign Application Priority Data
Mar. 15, 2019 (UA) A 2019 02561

(51) Int. Cl. H04N 5/232; G06T 19/00

(52) U.S. Cl. CPC H04N 5/23267; G06T 19/006; H04N 5/23258; H04N 5/23254

(57) ABSTRACT

The invention relates to vehicles, in particular to cars, and can be used to compensate their shaking in relation to augmented reality systems on projection display. The apparatus comprises the recognition front facing camera, gyro sensor and accelerometer, and vehicle sensors, connected with a prediction module, the gyro sensor, accelerometer and vehicle sensors are also connected with the positioning module, the gyro sensor and accelerometer are also connected with the shaking compensation module, the prediction module, positioning module, shaking compensation module, and vehicle sensors are connected with the data rendering module, connected with the projection display. The invention shaking compensation for automotive augmented reality systems.

### FIELD OF INVENTION

The invention relates to vehicles, in particular to cars, and can be used to compensate and predict their shaking in order to display the augmented objects.

### BACKGROUND

A vehicle's windscreen display unit is known to create a virtual image in the driver's field of view inside the vehicle. The display unit contains emission unit to generate and emit an image signal, which is projected onto the windscreen in the driver's field of view. The driver perceives the projected image signal as a virtual image. The display unit contains at least one movable reflector affecting the projection path section. The virtual image representation is affected by the controlled movement of the emission unit and is additionally affected by changes in the signal of the emitted image relative to the image signal at the center position of the mirror. The movement of the emission block is performed depending on the recognized traffic situation [DE20151011616A1, 2017 Mar. 9].

The known unit is used to display virtual objects, providing the possibility to correct this display with two methods, without providing the mechanism of estimation and predicting the required corrections as such. Accordingly, the description of the device lacks the units required for the process under consideration and is itself a part of the described system with the required feature—the possibility of image compensation.

A display apparatus is known for a vehicle, in which the image sensor is designed to display at least one type of augmented object on the surface located in the vehicle. The display apparatus contains a compensation tool by which, depending on the movement of the vehicle, an image compensation mechanism is implemented for at least one type of displayed augmented object [DE102016009506A1⋅2017 Apr. 13].

The described apparatus does not contain a high-frequency shaking compensation unit and corresponding frequency separation mechanism to compensate. The absence of cascade connection of the apparatus units makes the cascade process of compensation impossible, said process is one of the key elements of the invention, allowing to use the method optimal in terms of frequency, latency and accuracy for compensation of shake components having different nature of appearance. Also, the connection of the units proposed in the known apparatus, does not allow an accurate assessment of time latencies that require a separate approach to compensation, in addition to the compensation of the spatial component for different frequencies. The method proposed in the well-known device suggests fixing the position of virtual objects immediately before the process of displaying, while the proposed method predicts low-frequency changes in the relative position of objects among themselves and relative to the objects of the real world, which allows to level out the latency arising in the display device (projection display).

The closest to the claimed invention is the display apparatus for a vehicle containing an image generator to display at least one type of augmented object on a surface located in the vehicle. At least one type of augmented object may be adjusted according to the movement of the vehicle with a compensating device designed to at least compensate for the vehicle's own motion. To this end, the compensating apparatus is connected to the recognition apparatus, by means of which at least the vehicle ego state can be detected, and the movement of the vehicle can be caused by the specified state. The compensating apparatus is designed to modify at least part of the information corresponding to one type of augmented object on the basis of the results received from the recognition apparatus [DE102015007518A1⋅2016 Feb. 25].

The well-known apparatus has two units—recognition device and a device for display of information with the possibility of compensation. The recognition device in a car has high values of latency from the signal receiving till the results of its recognition, which makes it impossible to use the said device for compensation the main effects that are the subjects of the proposed device. The absence of predictive units and high-frequency compensation also makes it impossible to obtain the results expected for the projection display.

The method of preparation of information about the environment near the vehicle is known, where real environmental objects near the vehicle are visually displayed, and these virtual objects are superimposed in the form of augmented reality with real objects. According to the current movement profile of the vehicle and/or movement profile of at least one real object near the vehicle, the time for virtual object displaying is determined [DE102016009506A1].

This method does not contain the last stage of the gyroscopic and accelerometer shake assessment, which has the highest frequency and accuracy and allows to achieve the described result and provide the frequency separation of such shakes for further compensation.

The said method describes the compensations associated with the motion of the vehicle and surrounding objects, taking into account the time latencies and prediction, however without the connection of said process with the last step of high-frequency compensation.

The method lacks the separation of obtained result into different frequencies. This is an essential part of the proposal, because it allows for optimal compensation based on testing and experiments that reveal which shaking elements need to be compensated and which only lead to a deterioration in perception and distraction of a driver.

The main sources of data latency are not identified, which leads to difficulties in the practical implementation of the system. Without them, it is also impossible to separate into different compensation frequencies, as they depend on the frequencies and latencies not only in receiving the data, but also in delivering thereof.

In the prototype method, the relative position of the displayed objects is determined at the minimum time before the display. Taking into account the time on the projection display, this approach introduces an additional latency of at least 20 ms for existing design technologies (DMD—digitalmicromirrordevice), even for low-frequency predicted movements of the car and surrounded objects, which are the main focus of the prototype.

### SUMMARY

The basis of the invention is the creation of an apparatus of shaking compensation for automotive augmented reality systems, which provides the complex correction of the position of the augmented objects, arising from the fact that the image on the display is perceived by the driver with zero latency, compensation for overcoming the hillocks or road bumps, compensation for various frequencies and amplitudes of the vehicle oscillations, which would make it possible to separate these oscillations from other vehicle oscillations, to distinguish their predicted portion, and to classify the remaining oscillations in order to compensate them optimally.

The second object of the invention, is the creation of the method of shaking compensation for automotive augmented reality systems, which is aimed at the complex correction of the position of the augmented objects, arising from the fact that the image on projection display is perceived by the driver with zero latency, while the data are delayed, as well as at compensation of various frequencies and amplitudes of the vehicle oscillations in order to separate these oscillations from the other vehicle displacements, and to separate their predictable portion.

The object set is solved by the fact that the apparatus of shaking compensation for automotive augmented reality systems, comprising a shaking compensation module, according to the invention comprises a recognition front facing camera, gyro sensor, accelerometer and vehicle sensors, connected with a prediction module, the gyro sensor, accelerometer and vehicle sensors are also connected with a positioning module, and gyro sensor and accelerometer are also connected with the shaking compensation module, the prediction module, positioning module, shaking compensation module and vehicle sensors are connected with a module of data rendering, which is connected with the projection display.

The object set is also solved by the fact that the apparatus of shaking compensation for automotive augmented reality systems, comprising shaking compensation module, according to the invention comprises a front facing camera, gyro sensor, accelerometer and vehicle sensors connected with a recognition module, the recognition module, gyro sensor, and accelerometer and vehicle sensors are connected with prediction module, the gyro sensor, accelerometer and vehicle sensors are also connected with a positioning module, the gyro sensor and accelerometer are also connected with shaking compensation module, the prediction module, positioning module, and shaking compensation module and vehicle sensors are connected with a module of data rendering, connected with the projection display.

The second object set is solved by the fact that in the method of shaking compensation for automotive augmented reality systems, according to which the compensations, associated with the motion of a vehicle and surrounding object, are described considering time latencies and prediction, according to the invention, the recognition results from front facing camera are transferred into the prediction module with corresponding frequency and latency in relation to the moment of light entering onto a matrix of the front facing camera, and the gyro sensor and accelerometer transfer data into prediction module and into positioning module, vehicle sensors transfer data with various frequencies and latencies into prediction module and into positioning module, vehicle position and rotation are calculated by means of positioning module, as well as their relative displacement for the time moment, remoted from current moment by cumulative time of module operation, and transfer them into prediction module, where based on the data received, the positions of static and dynamic objects are predicted separately, the data from gyro sensor and accelerometer enter into the vehicle shaking compensation module, where the prediction of shaking low-frequency is made over the period of operation of rendering and data display modules, and the rest of the shaking are given with the predicted portion into the module of data rendering for visualization on projection display, while calculations are made in the data rendering module, and the part of or all the portions are added, which were integrated over the period of operation of shaking compensation module, and correction of the image being formed to compensate the displacement of driver's eyes is applied after all corrections in the rendering module, the final result for the driver is visualized on projection display.

The second object set is also solved by the fact that in the method of shaking compensation for automotive augmented reality systems, according to which the compensations connected with the motion of a vehicle surrounding and objects are described, considering time latencies and prediction, according to the invention, a video stream from front facing camera is transferred into the recognition module, the gyro sensor and accelerometer and vehicle sensors transfer data into recognition module, where the surrounding objects are recognized based on data received, and results of recognition are transferred into prediction module, the gyro sensor and accelerometer transfer data into prediction module and into positioning module, the vehicle sensors transfer data with various frequencies and latencies into prediction module and into positioning module, vehicle position and rotation are calculated by means of positioning module, as well as their relative displacement for the time moment, remoted from current moment by cumulative time of modules operation and transfer them into prediction module, where the positions of static and dynamic objects are predicted separately based on the data received, the data from gyro sensor and accelerometer enter into shaking compensation module of a vehicle, where the prediction of shaking low-frequency is made over the period of operation of rendering and data display modules, and the rest of the shaking are given with the predicted portion into the module of data rendering for visualization projection display, while calculations are made in the data rendering module and the part of or all the portions are added, which were integrated over the period of operation of the shaking compensation module, and correction of the image being formed to compensate the displacement of driver's eyes is applied after all corrections in the rendering module, the final result for the driver is visualized on projection display.

The cascade approach, built from lower frequencies data having longer latencies, but with better accuracy, to those that come more often and faster, but having the ability to accumulate errors over time, in modern cars, distinguishes the claimed apparatus from the prototype.

The apparatus uses all the data—both about ego-motion, and about the motion of static and dynamic objects, and from the high-frequency accelerometer and gyro sensor, and from the prediction module. Unlike well-known analogues, using no more than two of these mechanisms or using them without taking into account their interconnection, the proposed approach allows to obtain high-quality results, providing high requirements for apparatuses of that type:

latency at level of the display system operation time;
elimination the accumulation of errors in correction and prediction;
use of data as soon as possible after their obtaining;
efficient use of data at the maximum available frequencies;
the possibility of various shaking compensation strategies for different shakes nature.

Effective compensation of high-frequency changes in the position and angle of a vehicle is inextricably linked with the compensation of its own motion and the movement of other objects at frequencies below this compensation, this connection is shown in the claimed invention, and the result achieved is due to the proposed cascade scheme of compensation from lower frequencies to higher ones.

Unlike the prototype, the inventive method allows to build optimal compensation based on testing and experiments that reveal which shaking elements need to be compensated, and which only lead to poor perception and distraction of the driver.

Compared with the prototype, where the relative position of the displayed objects is determined for the minimum time before the display, the claimed invention does not have this drawback, since the position determination takes into account the prediction with a time advance corresponding to the time of the physical display process, including additionally low-frequency shaking, too.

### BRIEF DESCRIPTION OF THE DRAWINGS

The invention is illustrated by diagrams.

FIG. 1 illustrates the apparatus of shaking compensation of a vehicle, in which the camera provides recognized objects;

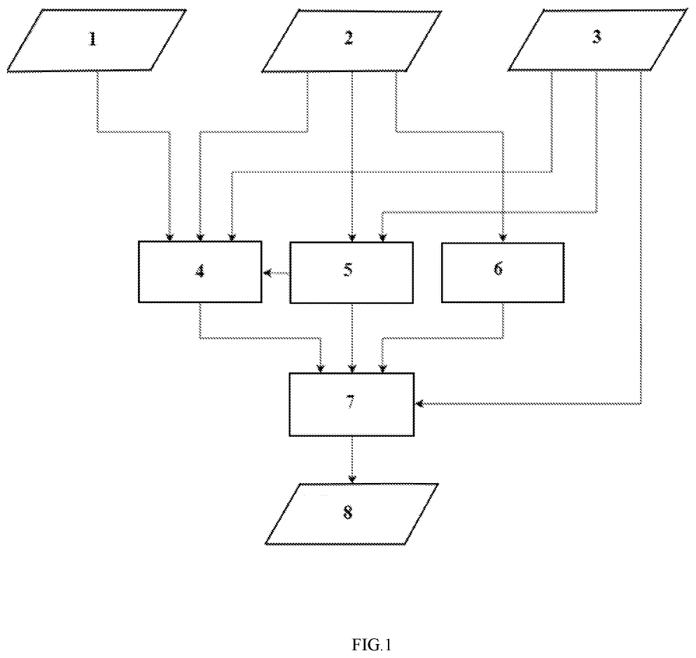

FIG. 2 illustrates the apparatus of shaking compensation of a vehicle, in which the camera provides a video stream.

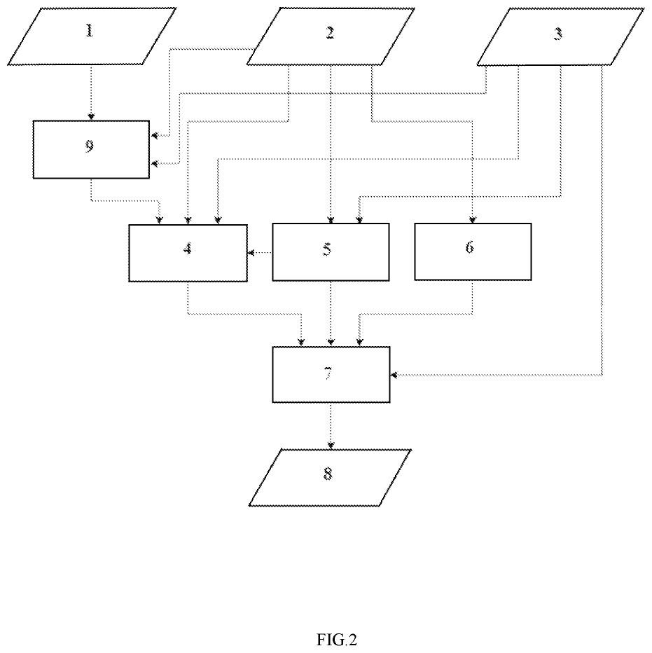

### DETAILED DESCRIPTION OF THE PREFERRED EMBODIMENT

The apparatus of shaking compensation of a vehicle according to the first embodiment comprises the recognition front facing camera 1, providing recognized objects, gyro sensor and accelerometer 2 and vehicle sensors 3, connected with the module 4 of prediction of own motion and movements of surrounding objects, which calculates relative displacement and absolute position of the vehicle, including rotation around three axes. The gyro sensor and accelerometer 2 and vehicle sensors 3 are also connected with the positioning module 5, and gyro sensor, accelerometer 2 are also connected with the shaking compensation module 6, operating based on gyro sensor and accelerometer measurement. The prediction module 4, positioning module 5, shaking compensation module 6 and vehicle sensors 3 are connected with the data rendering module 7 for display on projection display 8, with which it is connected.

The apparatus of shaking compensation of a vehicle according to the second embodiment comprises the front facing camera 1, providing a video stream, gyro sensor and accelerometer 2 and vehicle sensors 3 (at least a steering wheel rotation and vehicle speed), connected with the module 9 for recognition of own motion, surrounding dynamic objects and surrounding static objects by video stream. The recognition module 9, gyro sensor and accelerometer 2 and vehicle sensors 3 are connected with the prediction module 4. The gyro sensor and accelerometer 2 and vehicle sensors 3 are also connected with the recognition module 5, and gyro sensor and accelerometer 2 are also connected with the shaking compensation module 6. The prediction module 4, positioning module 5, shaking compensation module 6 and vehicle sensors 3 are connected with the data rendering module 7, connected with the projection display 8.

The apparatus of shaking compensation of a vehicle operates as follows.

In the first embodiment, the recognition front facing camera 1 transfers the recognition results into the prediction module 4 with a frequency of F₁A and latency in relation to the moment of light entering onto a matrix of the front facing camera 1.

In the second embodiment, the front facing camera 1 transfers the video stream into the recognition module 9 with a frequency of F₁B and latency in relation to the moment of light entering onto a matrix of the front facing camera 1. Gyro sensor and accelerometer 2 transfer data with a frequency of F₂ and latency into the recognition module 9. Sensors 3 of a vehicle transfer data with various frequencies and latencies to module 9. The recognition module 9, based on the data received, recognizes surrounding objects with the frequency of F₁B and transfers the recognition results into the prediction module 4 with the frequency of F₁B and latency in relation to the moment of light entering onto a matrix of the front facing camera 1.

Further, for both embodiments, the process is similar. Gyro sensor and accelerometer 2 transfer data into prediction module 4 with a frequency of F₂, and also into positioning module 5. The sensors 3 of a vehicle transfer data with various frequencies and latencies to prediction module 4, as well as to the positioning module 5. The positioning module 5 calculates the position of a vehicle and its relative displacement and transfers them to the prediction module 4 at required possibly changing frequency, F₄.

The positioning module 5 calculates the position and rotation of a vehicle and their relative displacement for the time moment, remoted from current moment by cumulative time of module operation 4, 7 and 8, and transfer them into data rendering module 7 with a frequency of F₄.

Based on the data received, prediction module 4 predicts separately the positions of static and dynamic objects, subtracting the latter from the model as the predicted nonrandom values of their movements and also higher frequency data from the gyro sensor and accelerometer 2, integrating them for the corresponding available time interval. The prediction occurs for the time moment, remoted from the time of results prediction by cumulative time of module 7 and 9 operation.

The shaking compensation module 6 of a vehicle receives the data from gyro sensor and accelerometer 2 and makes the prediction of low shaking frequencies for the operation of the module 7 of rendering and displaying data time interval, and the rest of the shaking are provided as additive portions corresponding to different frequencies, combined with the predicted part of portions, to the data rendering module 7 for display on projection display 8.

The data rendering module 7 performs the calculation, adds a part or all the portions, which were integrated over the period of operation of shaking compensation module 6.

Outside the scope of the current review, the correction of the image being formed to compensate the displacement of driver's eyes is applied after making all the corrections described in the module 7.

The final predicted positions of all the augmented objects estimated by means of described cascade manner for the data transfer and visualization of the projection display 8 time interval, and corrected, is rendered and transferred to the projection display 8, where it is displayed, allowing a driver to see the final result in the form of a virtual scene in front of the vehicle, which objects movements correspond to the movements of real objects in the driver's field of view due to the proposed system.

1. An apparatus of shaking compensation for automotive augmented reality systems, comprising a shaking compensation module, characterized in that it comprises a recognition front facing camera, gyro sensor and accelerometer, and vehicle sensors, connected with a prediction module, the gyro sensor and accelerometer, and sensor radars are also connected with a positioning module, the gyro sensor and accelerometer are also connected with a shaking compensation module, the prediction module, positioning module, shaking compensation module and vehicle sensors are connected with a module of data rendering, connected with a projection display.

2. The apparatus of shaking compensation for automotive augmented reality systems, comprising the shaking compensation module, characterized in that it comprises a front facing camera, gyro sensor, accelerometer and vehicle sensors, connected with a recognition module, the recognition module, gyro sensor, accelerometer and vehicle sensors are connected with a prediction module, the gyro sensor, accelerometer and vehicle sensors are also connected with a positioning module, the gyro sensor and accelerometer are also connected with a shaking compensation module, the prediction module, positioning module, shaking compensation module, and vehicle sensors are connected with the module of data rendering, connected with the projection display.

3. A method of shaking compensation for automotive augmented reality systems, according to which the compensations are described, which are connected with the motion of a vehicle and surrounding objects, considering time latencies and prediction, characterized in that the recognition results from the front facing camera are transferred into the prediction module with corresponding frequency and latency in relation to the moment of light entering onto a matrix of the front facing camera, the gyro sensor and accelerometer transfer data into the prediction module and into positioning module, the vehicle sensors transfer data with various frequencies and latencies into the prediction module and into positioning module, a vehicle position and rotation are calculated by means of positioning module, as well as their relative displacement for the time moment, remoted from current moment by cumulative time of modules operation, and they are transferred into the prediction module, where, based on the data received, the positions of static and dynamic objects are predicted separately, the data from gyro sensor and accelerometer renter into the shaking compensation module of a vehicle, where the prediction of low-frequency shaking is made over the period of operation of data rendering and data display module, and the rest of the shaking are given with the predicted portion into the data rendering module for visualization on projection display, while in the data rendering module the calculation are performed, adding a portion or all components, which were integrated over the period of shaking compensation module operation, and correction of the image being formed to compensate the displacement of driver's eyes is applied after all corrections in the rendering module, the final result for the driver is visualized on projection display.

4. A method of shaking compensation for automotive augmented reality systems, according to which the compensations are described, connected with the motion of a vehicle and surrounding objects, considering time latencies and prediction, characterized in that the video stream is transferred from front facing camera into recognition module, the gyro sensor, accelerometer and vehicle sensors transfer data into the recognition module, where, based on data received, it recognizes surrounding objects and transfers the prediction results into the prediction module, and gyro sensor and accelerometer transfer data into the prediction module and into positioning module, the vehicle sensors transfer data with various frequencies and latencies into the prediction module and into positioning module, a vehicle position and rotation are calculated by means of positioning module, as well as their relative displacement for the time moment, remoted from current moment by cumulative time of modules operation, and they are transferred into the prediction module, where, based on the data received, the positions of static and dynamic objects are predicted separately, the data from gyro sensor and accelerometer enter into the shaking compensation module of a vehicle, where the prediction of low-frequency shaking is made over the period of operation of data rendering and data display modules, and the rest of the shaking are given with the predicted portion into the module of data rendering for visualization on projection display while calculations are made in the data rendering module, where a portion or all components are added, which were integrated over the period of the shaking compensation module operation, and correction of the image being formed to compensate the displacement of driver's eyes is applied after all corrections in the rendering module, the final result for the driver is visualized on projection display.
